(19) United States
(12) Patent Application Publication
(10) Pub. No.: US 2006/0096920 A1
(43) Pub. Date: May 11, 2006

(54) System and method for conditioning water

(75) Inventors: Raul Eduardo Ayala, Clifton Park, NY (US); James Day, West Palm Beach, FL (US); Thomas Joseph Fyvie, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/982,731

(22) Filed: Nov. 5, 2004

(51) Int. Cl. B01D 61/00

(52) U.S. Cl. 210/639; 210/650; 210/259; 210/321.6; 210/652

(57) ABSTRACT

System and method for conditioning water. In one embodiment, a softening membrane selectively rejects hardness ions in a supply of water. In another embodiment, the softening membrane is used in conjunction with a purification device configured to remove impurities from a portion of output flow of softened permeate water. In a third embodiment, the softening membrane is used in conjunction with a conditioning agent dosing unit configured to supply at least one conditioning agent to an input flow of water entering the membrane to prevent membrane fouling. In still another embodiment, a water quality monitoring unit is configured to monitor water quality of the output flow of softened permeate water and a portion of concentrate water recycled back through the softening membrane.

### BACKGROUND OF THE INVENTION

This invention relates generally to water conditioners and more particularly to a water conditioner that softens and purifies water.

Many residences that use groundwater as their water source or obtain water from municipal water supplies will have “hard” water. Hard water contains high levels of divalent “hardness” ions such as calcium and magnesium that combine with other ions and compounds to form a hard, unattractive scale. This can result in formation of an unattractive film on sinks, bathtubs, dishes and cooking utensils. In addition, hard water deposits can form on clothing, resulting in discoloration and reduced fabric softness and clothing life. Also, hard water can affect skin and hair. Furthermore, hard water may impair plumbing through scale build-up on pipes.

One approach that has been used to “soften” water for residential applications involves ion exchange technology that removes the hardness ions and replaces them with a monovalent “soft” ion such as sodium. A typical ion exchange water softener uses a cation resin “bed” made up of bead-like material. The beads, having both positive and negative functional groups in its chemical structure, attract and hold positively charged ions (i.e., cations), such as sodium or hydrogen (i.e, hydronium), and will exchange them whenever the beads encounter another positively charged ion, such as calcium or magnesium. During a typical softening cycle, hard water passes through the resin bed, where the bead-like material has affinity for and holds the hardness ions such as calcium, magnesium, and iron while releasing “soft” cations such as sodium or hydrogen to the effluent water from the resin bed. Eventually the bead-like material becomes saturated with calcium or magnesium ions and no longer remove sufficient hardness from the incoming water. At this point, the bead-like material requires replenishment or regeneration with a liquid stream containing soft cations such as sodium, potassium or hydronium ions. Regeneration occurs by washing the resin bed with a strong salt water or brine solution (sodium chloride) stored in a brine tank. The brine solution forces the resin bed to release calcium, magnesium and other hard ions, where they are then discharged as waste. After regeneration, the resin bed is ready to exchange hardness ions of calcium and magnesium from the water for sodium. Alternate regeneration of the resin bed can be accomplished with acid solutions (i.e., by supplying hydrogen ions) or with potassium chloride solutions (i.e., by supplying potassium ions); the latter case being recommended for residential potable water where a sodium-restricted diet is indicated.

Although ion exchange water softeners are suitable for many applications, there are several disadvantages associated with their use. For example, a typical cation exchange water softener is not capable of removing neutral or anionic (i.e., negatively charged) impurities or contaminants from a supply of water because it is only configured to remove positively-charged hardness ions. As a result, contaminants such as bacteria, microorganisms, arsenic, etc. can pass through the ion exchange water softener for general consumption. Another disadvantage associated with the ion exchange water softeners is that users must regenerate the resin bed with the brine solution periodically, which means purchasing large, heavy bags of salt pellets to prepare the solution, and regenerate the bed off-line, meaning that the resin bed is precluded from producing soft water while undergoing regeneration, a process that can take up to several hours to complete. Furthermore, the disposal of brine solution used in the regeneration of the resin bed is problematic quite often in many geographical locations. In particular, excess brine solution that results from the regeneration of the resin bed is discharged as waste through the sewer or a septic tank. A typical water treatment plant generally does minimal cleaning of wastewater that it receives, but for the most part, does not remove the salt present in the discharged brine solution. However, in some locations where the processed water is used for agricultural purposes, the brine solution will permeate into the soil and change the composition of the soil and affect crops. It is also possible that the brine solution can find its way into lakes, streams, ponds, reservoirs, etc., and eventually affect fauna and flora. In order to prevent these problems, many areas have instituted anti-brine discharge regulations.

Reverse osmosis is another approach used to soften water. Reverse osmosis is typically used to desalinate or demineralize sea water, brackish water, or deionize industrial water for applications in fields such as semiconductors and pharmaceuticals. In these industrial applications, a reverse osmosis membrane that is semi-permeable receives water at a high pressure and substantially separates all of the ions and minerals that exist in the water. A high pressure is necessary because the membrane has a low flux which enables it to separate ions and minerals. The purity of water that is generated from using these industrial reverse osmosis membranes is quite high and is why they are suitable for semiconductor and pharmaceutical applications. Attempts have been made to use these industrial reverse osmosis membranes for residential applications, but there are limitations. For instance, because there is removal of ions that constitute alkalinity in water and have pH buffering capacity, there is a potential to generate corrosive water, especially for copper pipes existing in private residences. Corrosive water is possible because these reverse osmosis membranes remove all ions including carbonate/bi-carbonate ions that form a beneficial passivation layer on the copper pipes that inhibits corrosion from developing. Another limitation associated with using reverse osmosis membranes in a residential point-of-use water system is that they typically are unable to deliver the requisite amount of soft water at peak times. In particular, most of these point-of-use reverse osmosis membranes have a water recovery rate that is below 50% and a delivery flow that is less than 0.5 gallons/minute at typical residential water pressures of 50-100 psi. Since typical peak residential use is at around 10 gal/minute, these point-of-use reverse osmosis membranes are unable to meet demands at peak times.

Another approach that has been used to soften water for residential applications involves the use of nanofiltration membranes. A nanofiltration membrane is a semi-permeable membrane, but unlike the reverse osmosis membrane, does not reject ions to the same degree because it relies on surface charges to preferentially reject divalent and polyvalent cations while allowing substantial passage of monovalent ions. However, the nanofiltration membrane exhibits a higher water flux rate. This means that fewer membrane elements are required to provide the same or higher water flux or that it can operate at a lower membrane feed pressure. Like the reverse osmosis membranes, the conventional nanofiltration membranes are not well suited for high water recovery in residential applications. In particular, as the desired rejection of hardness ions increases, the cation concentrations in the concentrate or reject stream increase, the solubility limit of many of these salts, such as calcium and magnesium carbonates, is exceeded, causing salts to precipitate onto the membrane. The precipitation of salt deposits adheres to the membrane as a scale causing the membrane to eventually plug, which leads to fouling and a reduction in water flux. For instance, residential waters having an initial hardness of 10 grains per gallon will have exceeded the solubility limit of calcium carbonate, the main component of hardness, at a water recovery of 75%. At this value of water recovery, the water softening system will discard 1 gallon of waste concentrated water for every 3 gallons of softened product water that it produces, resulting in a 33% increase in the water usage for the customer. Thus, it is highly desirable to minimize the total water usage experienced by the residential water user.

In view of the problems noted above, a need exists for an improved water-softening system.

### BRIEF DESCRIPTION OF THE INVENTION

In one embodiment, there is a system for conditioning water. In this embodiment, there is a softening membrane that selectively rejects hardness ions in a supply of water. The softening membrane is configured to receive an input flow of water, discharge an output flow of softened permeate water and discharge an output flow of first concentrate water. A purification device is configured to remove impurities from a portion of the output flow of softened permeate water and discharge an output flow of second concentrate water.

In another embodiment, there is a system for conditioning water. In this embodiment, there is a conditioning agent dosing unit configured to supply at least one conditioning agent to an input flow of water. A softening membrane selectively rejects hardness ions in the conditioned flow of water. The softening membrane is configured to discharge an output flow of softened permeate water and discharge an output flow of first concentrate water, wherein a portion of the first concentrate water is recycled back through the conditioning agent dosing unit and softening membrane, wherein the at least one conditioning agent prevents membrane fouling.

In still another embodiment, there is a residential water system. In this embodiment, there is at least one filter configured to filter an input flow of water. A conditioning agent dosing unit is configured to supply at least one conditioning agent to the filtered input flow of water. A softening membrane selectively rejects hardness ions in the conditioned flow of water. The softening membrane is configured to discharge an output flow of softened permeate water and discharge an output flow of first concentrate water, wherein a portion of the first concentrate water is recycled back through the conditioning agent dosing unit and softening membrane, wherein the at least one conditioning agent prevents membrane fouling. A water quality monitoring unit is configured to monitor water quality of the output flow of softened permeate water.

In a fourth embodiment, there is a method for conditioning water. In this embodiment, an input flow of water is received. At least one conditioning agent is supplied to the input flow of water to prevent scale formation. A softening membrane is used to selectively reject hardness ions in the water. An output flow of softened permeate water is then discharged. An output flow of first concentrate water is also discharged. A portion of the first concentrate water is recycled back for supply of at least one conditioning agent and use of the softening membrane.

### BRIEF DESCRIPTION OF THE DRAWINGS

FIG. 1 shows an exploded cut-away view of a softening membrane used for water softening according to one embodiment;

FIG. 2 is a schematic showing concentration polarization of feed water near a membrane surface while operating in a cross-flow mode;

FIG. 3 shows the softening membrane of FIG. 1 in a system for conditioning water according to one embodiment;

FIG. 4 is another embodiment showing the softening membrane of FIG. 1 in a system for conditioning water;

FIG. 5 shows average “A” value and water recovery results from tests performed on membranes described in one embodiment;

FIG. 6 shows average “A” value and hardness results from tests performed on membranes described in one embodiment;

FIG. 7 shows relative flow results of a membrane according to one embodiment in which an inhibitor is utilized;

FIG. 8 shows flow rate results of softened permeate water and concentrate for a test performed on a membrane according to one embodiment;

FIG. 9 shows flow rate results of softened permeate water and concentrate for a test performed on a membrane according to one embodiment where a portion of the concentrate was recycled back through the membrane;

FIG. 10 shows flow rate results of a membrane according to one embodiment, with and without the use of an inhibitor; and

FIG. 11 shows additional results of a membrane used in conjunction with a scale inhibitor.

### DETAILED DESCRIPTION OF THE INVENTION

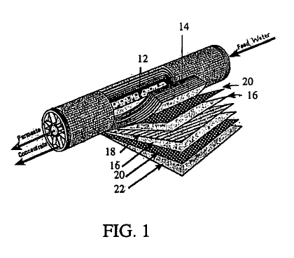

FIG. 1 shows an exploded cut-away view of a softening membrane 10 used for water softening according to one embodiment. The softening membrane 10 is a semi-permeable material that can separate components of a feed solution such as water into a permeate that passes through the material and a concentrate that is rejected or retained by the material. In this embodiment, the softening membrane 10 rejects hardness ions that are divalent such as calcium, and magnesium. The softening membrane 10 is not limited to removing only calcium and magnesium and can remove multivalent ions such as iron, sulphate, and carbonates.

The softening membrane 10 includes a perforated central tube 12 in which a thin film composite membrane 14 is spirally wound. The thin film composite membrane 14 includes at least one thin film or matrix layered on a porous support membrane. A thin film or matrix is generally a regular, irregular and/or random arrangement of polymer units such that on a macromolecular scale the arrangements of such units may show repeating patterns, or may show series of patterns that sometimes repeat and sometimes display irregularities, or may show no pattern respectively. The polymer units may or may not be fully cross-linked. FIG. 1 shows that the thin film composite membrane 14 includes a pair of membrane elements 16 and a permeate collection material 18 disposed between the elements. The membrane elements 16 are disposed between a pair of feed channel spacers 20. An outer wrap 22 covers the membrane elements 16, permeate collection material 18 and feed channel spacers 20. Other membrane module configurations may use used, such as plate-and-frame modules, and cassette-type modules.

In this embodiment, each of the membrane elements 16 is a polyamide membrane which is a composite of an amide polymer matrix located on at least one side of a porous or microporous support material. One of skill in the art will recognize that other classes of polymers are suitable for use as the membrane such as cellulose acetate, polysulfonamides, polysulfone, cross-linked polyethers, polyacrylonitrile, etc. With regard to the porous support material, it may be composed of any suitable porous material including but not limited to paper, modified cellulose, woven glass fibers, porous or woven sheets of polymeric fibers and other porous support materials made of polysulfone, polyethersulfone, polyacrylonitrile, cellulose ester, polyolefin, polyester, polyurethane, polyamide, polycarbonate, polyether, and polyarylether ketones including such examples as polypropylene, polybenzene sulfone, polyvinylchloride, and polyvinylidenefluoride. Ceramics, including ceramic membranes, glass and metals in porous configurations are also included.

Although the softening membrane 10 is described as a thin film composite, it is possible to form the membrane as flat sheets, hollow fibers, cassettes or coated tubes. Each one of these forms can be configured into a membrane that can manage the flow of feed water therethrough in the manner described below.

The softening membrane 10 can be enclosed within a housing. Typically, the housing is an elongated, tapered sump having a tapered inner wall, a bottom wall and an upper connecting flange. The connecting flange is generally integrally joined with the top edge of the wall and is provided with internal threads complementary to received external threads of an end cap. The bottom wall includes a centrally positioned bottom opening in communication with a concentrate outlet conduit. The outlet conduit can have a concentrate valve to control the flow of concentrate through the conduit. The description of this housing is only for illustrative purposes, and one of ordinary skill in the art will recognize that other types of housing can receive the softening membrane 10.

The softening membrane 10 operates in a cross-flow mode where feed water is introduced at one end of the membrane as shown by a labeled arrow in FIG. 1 and is caused to flow through the feed channel spacers 20 towards the opposite end. During this flow, the feed water is exposed to the surface of the membrane elements 16 under pressure and a portion is caused to pass through the membranes and into the permeate collection material 18 as a result of pressure. Thus, during flow of the feed water from one end to the other, a certain portion of the feed will pass through the membrane elements 16 into the center of the perforated central tube 12 through its openings and out through the permeate outlet which is designated in FIG. 1 by a labeled arrow.

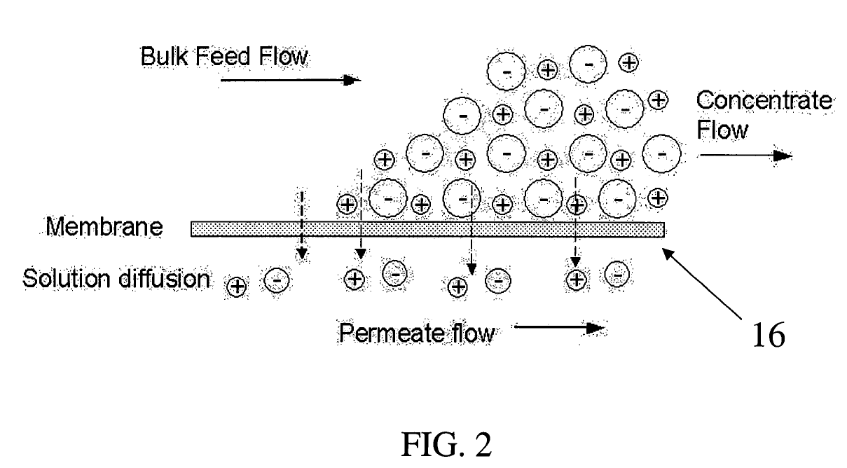

FIG. 2 is a schematic showing the concentration polarization of the feed water near a membrane surface while the softening membrane 10 operates in a cross-flow mode. FIG. 2 also shows the ability of the membrane element 16 to fractionate small compounds from the feed water that typically have molecular weights less than 1000. This is helpful in removing uncharged components such as lead, iron, and aluminum particles from the feed water. In addition, the membrane element 16 can permeate monovalent ions while retaining divalent and multivalent ions such as calcium, magnesium, iron, etc. by utilizing the principles of Donnan's exclusion. The retained uncharged components, divalent and multivalent ions are removed from the membrane as concentrate flow.

The softening membrane of this embodiment is generally designed to provide high quality water softening for residential applications and non-industrial institutional applications in either a point-of-entry, or point-of-use, or combined configuration. As used herein, non-industrial institutions are small users of water that have water flow rate needs, water quality requirements and unattended operation needs such as those in residential applications. An illustrative, but non-exhaustive list of non-industrial institutions include medical offices, laboratories, private daycares services, and home-based businesses. Typically, the softening membrane 10 can remove at least 85 percent of hardness ions from an input flow feed water for both residential and non-industrial institutional applications. This enables the softening membrane to generate an output flow of softened permeate water that has a hardness ranging from about 0.1 to about 3 grains per gallon, wherein a desired range is from about 1 to about 3 grains per gallon. These hardness ranges provide the proper balance for preventing corrosion in copper piping. If the softening membrane were to remove all hardness ions and most other anions such as those components in alkalinity, then this would lead to corrosive water. On the other hand, having some residual hardness or carbonate/bicarbonate alkalinity which is the case with softening membrane 10, will prevent corrosion because a carbonate passivation layer forms to hinder the onset or progression of corrosion attack.

In order to use the softening membrane 10 for residential and non-industrial institutional applications, it needs to have a relatively high flux, water recovery, and expected hardness ion rejection to meet the needs of the users of these applications. As used herein, flux is the rate of flow of permeate through a unit area of the membrane. Under most circumstances the flux is directly related to the applied trans-membrane pressure (TMP). An “A value” is one measurement that one of ordinary skill in the art can use to represent the flux of the membrane divided by the applied TMP. An “A value” as used herein represents the water permeability of a membrane and is represented by the ratio of cubic centimeters per second of permeate water over the square centimeters of membrane area times the pressure measured in atmospheres. The A value is represented by the following equation:
A=permeate volumetric flow rate/(membrane area times net driving pressure)
Expressed in units of 10⁻⁵ cm/(sec atm), the softening membrane 10 of this embodiment has an A value that ranges from about 15 to about 50, or 15-50×10⁻⁵ cm/(atm sec).

In addition to a relatively high flux, the softening membrane 10 should have a relatively high water recovery to meet the needs of residential and non-industrial institutional applications, where there may be an input flow of water that is less than 15 gallons per minute and with a pressure that is greater than 20 pounds per square inch. As used herein, recovery is generally the ratio of softened permeate water flow to water feed flow expressed as a percentage. In addition, recovery can be used to calculate also the ratio of concentrate water flow to water feed flow. In this embodiment, the softening membrane 10 generates an output flow of softened permeate water that is at least 80 percent of the input flow of water, wherein a desired recovery is at least 90 percent of the input flow of water. In addition, the softening membrane generates an output flow of concentrate water that is less than 20 percent of the input flow, wherein a desired recovery is less than 10 percent of the input flow.

With the above-noted operating parameter characteristics, the softening membrane 10 has the advantage of not needing a storage or reservoir tank to store softened water for continuous high flow use. Although a storage or reservoir tank is not necessary with this embodiment, one of ordinary skill in the art will recognize that such a device or other process flow modifications can be configured to meet water demands that are outside the operating performance parameters of the softening membrane 10.

In this embodiment, the softening membrane 10 may comprise a nanofiltration membrane element as described above or a reverse osmosis membrane such as a “loose” reverse osmosis membrane. A “loose” reverse osmosis membrane is generally a reverse osmosis membrane that rejects ionic contaminants, but to a lesser degree than a reverse osmosis membrane. Selection on whether to use a nanofiltration membrane as opposed to a loose reverse osmosis membrane for a water softener will depend on the operating parameters that one desires to obtain. For example, the nanofiltration membrane can generate an output flow of softened permeate water that has a hardness ranging from about 1 to about 6 grains per gallon, while the loose reverse osmosis membrane can generate an output flow of softened permeate water that has a hardness ranging from about 0.1 to about 3 grains per gallon.

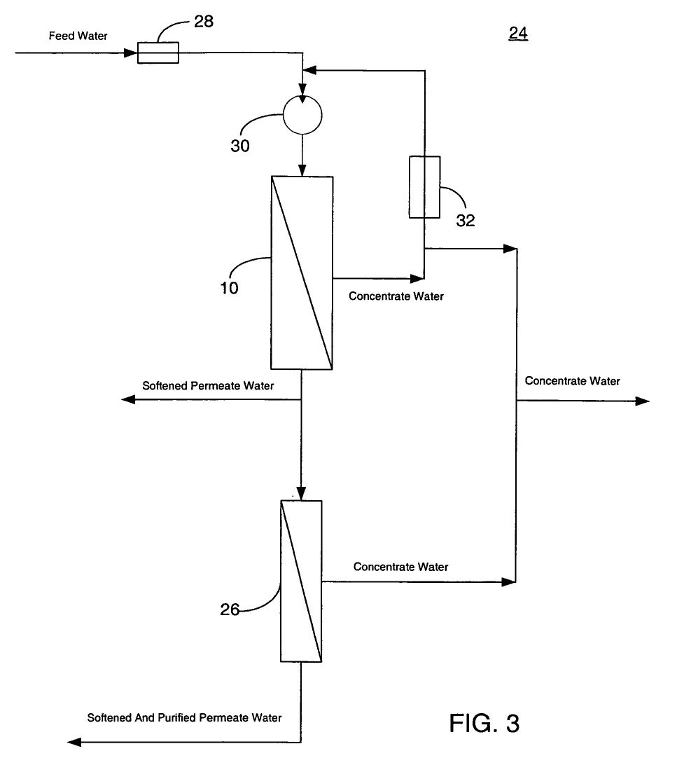

FIG. 3 shows the softening membrane in a system 24 for conditioning water according to one embodiment. In addition to the softening membrane 10, the water conditioning system 24 comprises a purification device 26 connected in series to the softening membrane. The purification device 26 is configured to remove additional impurities from a portion of the output flow of softened permeate water generated from the softening membrane. As used herein, impurities removed by the purification device 26 may include minerals, contaminants (e.g., radon, radium, arsenic, chloramine, dissolve iron, metals, sodium), additional hardness, and bacteria (e.g. viruses, giardia, crypotosporidium). The purification device 26 is also configured to discharge an output flow of second concentrate water. In this embodiment, the purification device 26 may comprise a membrane such as a demineralizing membrane like a “tight” reverse osmosis membrane or a loose reverse osmosis membrane. A “tight” reverse osmosis membrane differs from the loose reverse osmosis in that it rejects monovalent ionic contaminants to a higher degree. The tight reverse osmosis membrane will result in demineralized water while the loose reverse osmosis membrane results in partially demineralized water. In addition, the purification device 26 may comprise a filter such as an activated carbon filter for the removal of chlorine, sulfides, and other taste and odor sources.

Regardless of whether a tight or loose reverse osmosis membrane is selected, the purification device operates by taking the softened water from the softening membrane at the existing pressure and purifying it further to become purer water at the point of use, such as the refrigerator ice/water dispenser, the kitchen sink or the bathroom sink, places where lower flow rates are typically needed. The rejected concentrated stream is sent directly to the nearby drain or sewer line.

Although FIG. 3 shows that the softening membrane 10 and the purification device 26 as separate elements, one of ordinary skill in the art will recognize that one membrane can perform both softening and purification functions. A high flux, chlorine resistant loose reverse osmosis membrane is one example of a membrane that can perform both softening and purification. The loose reverse osmosis membrane performs both softening and purification by removing hardness ions as well as reducing bacteria, sodium, fluoride, arsenic, lead and other metal ions that are potentially toxic in higher concentrations.

Also, one of ordinary skill in the art will recognize that there are other possible configurations for the system shown in FIG. 3. For instance, it may be desirable to have the softening membrane 10 and the purification device 26 aligned in parallel as opposed to a serial connection so that not all the water flow has to be conditioned to the same extent and blending streams of different water qualities is desirable. Also, module size and shape could be different between the softening membrane 10 and the purification device 26.

FIG. 3 also shows that the water conditioning system 24 further comprises a prefilter 28 that filters particulates of a specified diameter from the feed water. Examples of particulates that the prefilter 28 may remove comprise elements such as bacteria, protozoa, and other microorganisms. In addition, the prefilter may remove sediments of a specified diameter and other items such as iron and chlorine. In this embodiment, the prefilter 24 may comprise a carbon filter, ceramic filter, or a UV disinfecting device. FIG. 3 shows the water conditioning system 24 only with one prefilter, however, one of ordinary skill in the art will recognize that more than one prefilter may be used. For example, one or more filters can act as a prefilter and one, or more other filters can acts as a polishing filter.

A pump 30 receives the filtered water and boosts the pressure. The amount of pressure boost will depend on whether the source of the feed water is a pressurized municipal supply, groundwater or well water. Typically, water pressure from one of these sources will be in the range of about 20 to about 120 pounds per square inch. The pump 30 will then boost the water pressure to a pressure that is greater than 20 pounds per square inch in order to maintain optimal performance of the softening membrane 10 and purification device 26.

FIG. 3 shows that a portion of the concentrate water generated from the softening membrane 10 is recycled back through the membrane. In particular, this portion of concentrate water passes through a filter 32 which captures any incipient scale produced during idle, maintenance or cleaning periods or bacterial film which will keep the softening membrane cleaner. Although FIG. 3 shows only one filter 32, the water conditioning system 24 may have more than one filter. In this embodiment, the filter 32 may comprise filters such as ceramic filters and strainers.

The water conditioning system 24 in FIG. 3 operates by receiving the feed water provided from a water source. The prefilter 28 filters particulates from the feed water such as bacteria, protozoa, and other microorganisms, as well as other items such as sediments (e.g., total suspended solids), iron and chlorine. The pump 30 receives the filtered water and boosts the pressure of the water to a pressure that is greater than 20 pounds per square inch. The feed water enters the softening membrane 10, where it is exposed to the surface of the membrane elements. A portion is caused to pass through the membranes and into the permeate collection material. The retained uncharged components, divalent and multivalent ions are removed from the membrane as concentrate flow. A portion of the softened permeate water is ready for use and consumption, while another portion of permeate enters the purification device 26 for additional removal of impurities. The purification device 26 generates softened and purified permeate water and discharges an output flow of concentrate water. A portion of the concentrate from the softening membrane 10 is recycled back to the membrane through the filter 32 and pump 30. The rest of the concentrate water from the softening membrane 10 and purification device 26 is discharged into a sewer along with the concentrate from the purification device 26.

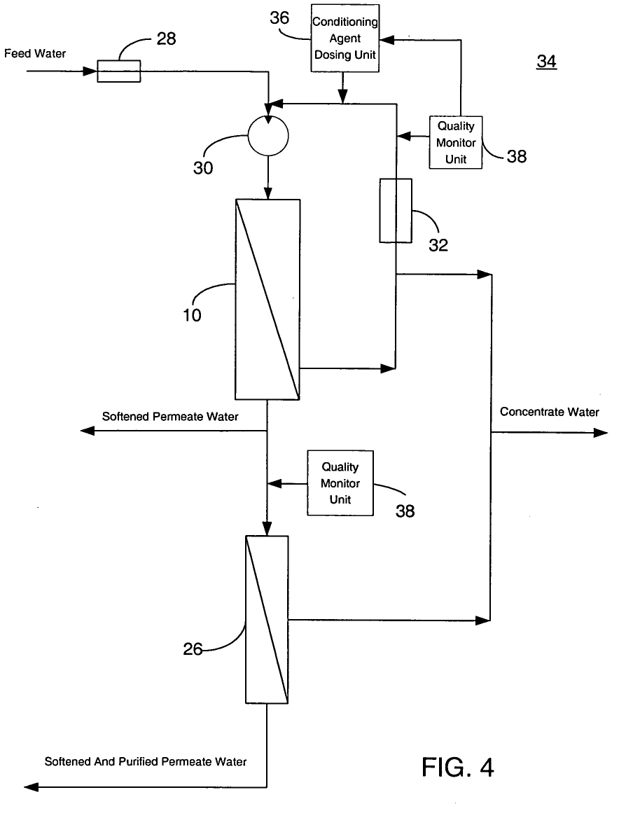

FIG. 4 is another embodiment showing the softening membrane 10 in a second system 34 for conditioning water. The second water conditioning system 34 is similar to the one shown in FIG. 3, except that the system 34 includes a conditioning agent dosing unit 36 configured to supply at least one conditioning agent to the feed water in order to prevent membrane fouling. Antiscalants have been used to prevent scale formation in industrial systems or processes when hard water is concentrated. EDTA (ethylenediaminetetracetic acid) and its derivatives is one type of antiscalant that has been used in these industrial applications. EDTA is not a viable option to prevent hardness scaling in residential systems. In particular, an average residence consuming 100,000 gal/year of water with a hardness of 10 grains/gal would require at least 500 lbs of EDTA to be added to prevent scale formation if a water recovery of 85% or higher is required. This amount is just not practicable or suitable for residential use.

The inventors have recognized the problems associated with EDTA and its derivatives for residential applications and have proposed the use of the at least one conditioning agent. In one embodiment, the at least one conditioning agent comprises one of a scale inhibitor, an antiscalant, a biofoulant suppressant, a pH adjustment chemical additive or combinations thereof. The at least one conditioning agent may also comprise a membrane cleansing agent. All of these conditioning agents are approved by the National Sanitation Foundation and are suitable for drinking and cooking.

The scale inhibitor agent, antiscalant (chelating) agent, pH adjustment chemical additive and membrane cleansing agent that may be provided by the conditioning agent dosing unit 36 are suitable for preventing scale formation and the need for cleaning of the softening membrane 10. These agents are useful because at some point the solubility limit of the softening membrane 10 is exceeded, causing salts to precipitate in the membrane elements. The precipitation of salts deposits or adheres to the membrane elements as a scale causing them to eventually clog. An example of the formation of membrane clogging is shown in FIG. 2. In particular, FIG. 2 shows the concentration polarization of ions accumulating near the surface of the membrane element, which will eventually precipitate as inorganic scale and reduce the effective flow of water across the element as this accumulation builds up. An illustrative but non-exhaustive list of scale inhibitor agents, antiscalant agents and membrane cleansing agents include calcium carbonate antiscalants, phosphonates, biocarbonate, barium sulphate, hydrochloric acid, sulphuric acid and biostatic agents such as benzoic acids, to prevent chlorine degradation.

The biofoulant suppressants that may be provided by the conditioning agent dosing unit 36 is suitable for reducing membrane fouling that generally arises from the formation of bacteria such as planktonic and sessile bacteria. An illustrative but non-exhaustive list of biofoulant suppressants includes biocides such as sodium metabisulfite (“sulfites”), and benzoates.

The water conditioning agents work in the softening membrane 10 by dissolving, flushing or displacing the feed/concentrate in the lumens of the membrane elements until a substantial part, and preferably all of the volume of the lumens of the elements are clean. With clean membrane elements, high water fluxes across the softening membrane can be maintained. Effluent of this operation is removed from the softening membrane 10 as concentrate and is sent to the sewer.

In this embodiment, the conditioning agent dosing unit 36 may comprise a container or containers that store the conditioning agents and a device to supply the conditioning agents to the feed water such as a valve like a solenoid valve. Other configurations may include a mechanical feeder that doses a desired amount of the agent(s) to the feed water through a valve. A micro fluidic module such as a MEMS-type dispenser in cooperation with a meter can supply the conditioning agent(s) to the feed water. These examples are illustrative of only few types of devices that can serve as the conditioning agent dosing unit, however, one of ordinary skill in the art will recognize that other configurations exist.

Referring back to FIG. 4, the water conditioning system 34 also comprises a water quality monitoring unit 38 configured to monitor the water quality of the output flow of softened permeate water. In particular, the water quality monitoring unit 38 monitors the softened permeate water via measurements of turbidity, refractive index, conductivity, pressure, flow and the like. These measurements are illustrative of some measurements that the water quality monitoring unit 38 may take and is not exhaustive. For example, one of ordinary skill in the art will recognize that the water quality monitoring unit can take measurements such as _pH, turbidity, hardness, total dissolved solids (TDS), chlorine and sulfides. In this embodiment, the water quality monitoring unit 38 may comprise devices such as a turbidity meter, an ion selective probe and a conductivity meter.

The water conditioning system in FIG. 4 also includes another water quality monitoring unit 38 configured to monitor the water quality of the portion of concentrate water recycled back through the softening membrane 10. The water quality monitoring unit 38 monitors the concentrate for fouling, scaling and incipient nucleation of crystals that form scaling. The water quality monitoring unit 38 comprises a control unit configured to control the supply of the at least one conditioning agent to the input flow of water in accordance with the monitored water quality. The water quality monitoring unit 38 is not limited to this configuration and as an alternative the unit may include an in-situ monitoring device that is placed near the membrane 10 so that it can track scale formation right at the membrane surface.

The water conditioning system 34 in FIG. 4 operates by receiving the feed water provided from a water source. The prefilter 28 filters particulates from the feed water such as bacteria, protozoa, and other microorganisms, as well as other items such as sediments, iron and chlorine. The pump 30 receives the filtered water and boosts the pressure of the water to a pressure that is greater than 20 pounds per square inch. The feed water enters the softening membrane 10, where it is exposed to the surface of the membrane elements. A portion is caused to pass through the membranes and into the permeate collection material. The retained uncharged components, divalent and multivalent ions are removed from the membrane as concentrate flow. A portion of the concentrate from the softening membrane 10 is recycled back to the membrane through the filter 32 and pump 30. As the water is recycled back, the water quality monitoring unit 38 monitors the water for fouling, scaling and incipient nucleation of crystals that form scaling. The water quality monitoring unit 38 provides a signal to control of supply conditioning agent(s) by the conditioning agent dosing unit 36 in accordance with the monitored water quality. The conditioning agent dosing unit 36 then supplies the conditioning agent(s) to the water which flows back into the softening membrane 10. During normal operation, the conditioning agent dosing unit 36 can supply the conditioning agent(s) continuously or periodically to maintain proper operation of the membrane (e.g., prevent scale formation). During idle or off-line time, the conditioning agent dosing unit 36 can supply the conditioning agent to dissolve, flush, rinse or dislodge any deposits that have accumulated on the membrane. Concentrate water that is not recycled backed to the softening membrane 10 is discharged into the sewer.

A portion of the softened permeate water is ready for use and consumption, while another portion of permeate enters the purification device 26 for removal of impurities. As the water enters the purification device 26, the water quality monitoring unit 38 monitors the water quality of the output flow of softened permeate water. In particular, the water quality monitoring unit 38 monitors the softened permeate water via measurements of turbidity, refractive index, conductivity, pressure, flow and the like. The purification device 26 then generates softened and purified permeate water and discharges an output flow of concentrate water, which is discharged into the sewer.

Although the water conditioning systems shown in FIGS. 3-4 are essentially point-of-entry systems, it is possible to configure them as point-of-use systems. For example, one could configure the softening membranelo in bathrooms to prevent residue build-up around sinks and tubs and near dishwashers to prevent build-up on dishes and utensils. Also, one could configure the softening membrane 10 near a washing machine to prevent water deposits from forming on clothing. One could then place the purification device in the kitchen and use it for drinking and culinary applications.

For the embodiments disclosed in FIGS. 34, it may be desirable to run feed water or even softened water through the membrane for a few seconds or a minute longer at prevailing (low pressure) city water pressure to displace the high concentration concentrate stream from the membrane lumens. Generally, when a demand for water has ended in a house, it is typical for the membrane module to be left with high hardness concentrate water on the concentrate side of the membrane. Under these circumstances, where the concentrate hardness may be above the saturation limit of the salts present in the water, it is very likely that the hardness salts will precipitate onto the membrane causing it to foul and form scale. To avoid the precipitation of hardness salts over time, it would be desirable to run feed water or softened water through the membrane for a few seconds or a minute longer at prevailing (low pressure) city water pressure to displace the high concentration concentrate stream from the membrane lumens and aid further in the dissolution of any previous hardness scale that might have previously formed or break ion concentration polarization or other contaminants that accumulate within the lumens.

This flushing process can be done automatically at the end of every water demand cycle, or periodically after a few hours of idle time. In this way, scale is prevented from forming and clogging the membrane over time during idle operation. In this configuration, the flushing water is sent as usual to the drain or sewer or to the usual discharge location for the concentrate. Furthermore, since most feed city waters are below their saturation level with respect to hardness, this state of flushing the membrane will foster the dissolution of any scale that might have formed and lodged within the membrane and help restore some of the initial higher flux. Additional benefits of this flushing method include breaking the ion concentration polarization, dislodging bacteria or debris, or other ions present.

The following examples of tests performed on various embodiments of the invention are illustrative and are not limiting.

### EXAMPLE 1

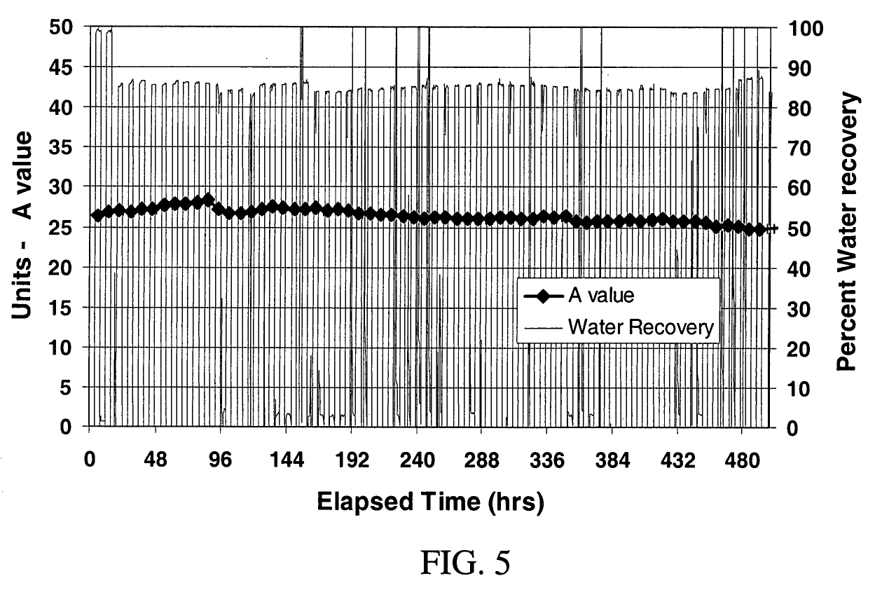

A batch of several 12-inch long GE Osmonics modules having AP-type membrane were screened for several modes of operation such as on-off cycle duration, dosage of scale inhibitor, membrane permeability and salt rejection over time. In addition, a one 40-inch long and 4-inch diameter module polyamide membrane available for production as a large commercial module was tested in a modified Osmonics E-4 unit, where flow rates in gal/min simulate residential operation. Tests were conducted using municipal water from the Town of Niskayuna, New York. Several of the 12-inch modules were taken apart and the membrane intrinsic permeability was measured. The intrinsic permeability for this batch exhibited “A” values ranging from 40 to 50. This is an improvement from another test batch that exhibited “A” values of 25. The 12-inch modules always exhibited a lower overall “A” than the larger 40-inch module due to tighter spiral winding and higher frictional fluid flow losses. Regardless, 85% water recovery was clearly achieved and sustained for the 12-inch modules as shown in FIG. 5. Note that the results shown in FIG. 5 were the product of a 4 hours on/4 hours cyclic operation with the “off” at about 90 psi feed pressure.

### EXAMPLE 2

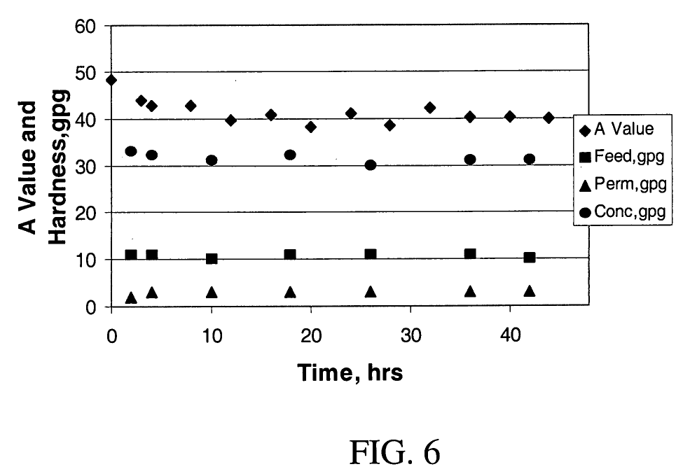

A GE Osmonics 4040 module, 4 inches in diameter and 40 inches in length having an AP-type membrane, was tested with scale inhibitor using municipal water from the town of Niskayuna in New York State. This test resulted in the membrane exhibiting a steady “A” value of 40 and 85% water recovery. In addition, the membrane received feed water having 10-11 grains/gal (gpg) of hardness and reduced it to softened water having 3 gpg of hardness, while discharging concentrate at slightly above 30 gpg. FIG. 6 shows the results of this test.

### EXAMPLE 3

Several 12-inch long GE Osmonics modules with AP-type membranes were tested at various process conditions of flow, scale inhibitor dosing, and carbon pre-filtering. Some results of this test were that the membranes allowed approximately 45% of the fluoride ions present in the city water to permeate through the membrane and remain in the softened water. Fluoride ions are typically added to city water by municipalities to prevent dental cavities in children. Conventional reverse osmosis membranes do not allow this as 99% of all the ions are removed. Other results were that the AP-type membranes rejected about 80% of the scale inhibitor added to the feed stream. This result is beneficial as the inhibitor is retained in the concentrate stream being recirculated, thus increasing the contact time with the membrane channels to prevent scaling. Note that the inhibitor is NSF approved and its presence is acceptable in potable water at low concentrations.

### EXAMPLE 4

A polymeric 12″ long GE Osmonics module having a polyamide AP-type membrane was put through a rigorous three week test to demonstrate the concept of scale formation prevention via the addition of scale inhibitors and dissipation of the ion boundary layer near the membrane with fast recycle flow for residential operation. The test was conducted in a sub-scale unit test unit and four modes of operation were compared at 90% water recovery:

Continuous (24/7) industrial reverse osmosis (RO) operation

Cyclic 4 Hr on/4 Hr off operation

Cyclic 5 second flush during continuous 24/7 flow

Cyclic 3 Hr on/3 Hr off operation

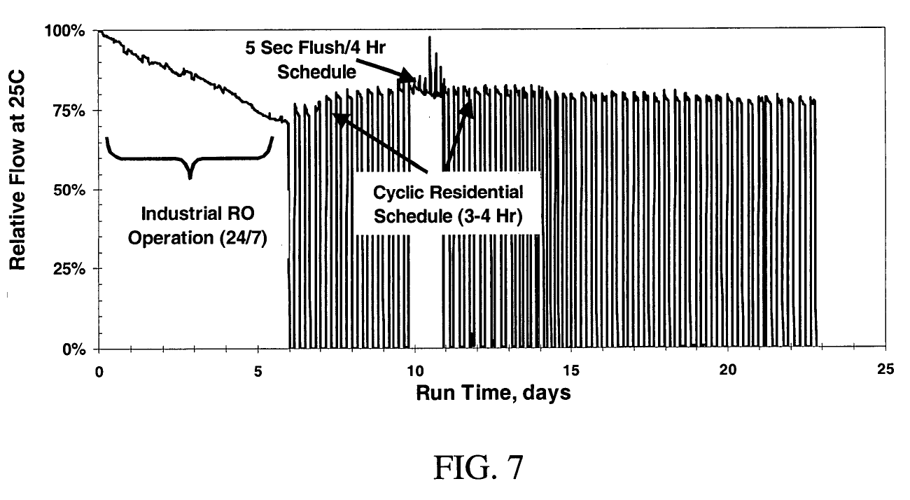

FIG. 7 shows that the initial six days of continuous operation, which was in industrial reverse osmosis mode, had a high 90% water recovery. This resulted in gradual plugging of the membrane, despite the presence of an inhibitor and the use of fast recycle flow. The turbulent flow alone was not sufficient in this case to fully break and displace away the ion boundary layer that forms near the membrane surface which promotes precipitation of scale. When the flow was switched to cyclic operation (i.e., a period of 3-4 hours of full flow followed by a period of no flow and no recycle) with inhibitor, the formation of scale on the membrane was successfully prevented over the remaining period of 17 days. The presence of the inhibitor in this test aided in redispersing the concentrated ions away from the membrane surface during idle time, thus preventing local supersaturation and precipitation near the surface.

### EXAMPLE 5

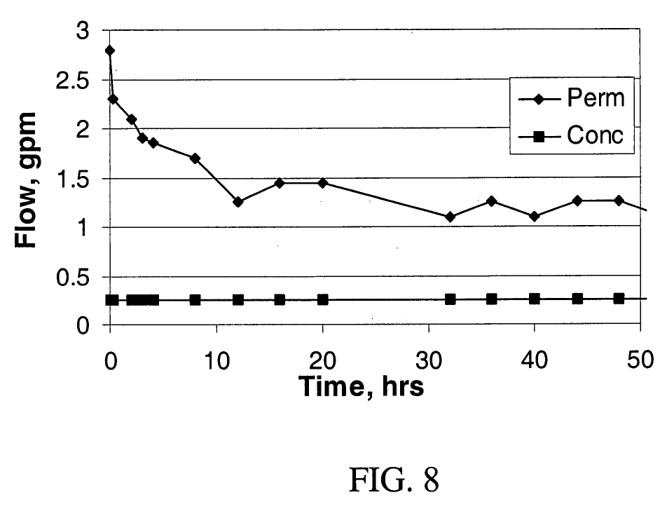

A GE Osmonics 4040 module with a reverse osmosis AK-type membrane was tested in a once-through test using city water from the Town of Niskayuna in New York State. Ninety percent of the feed water was recovered as softened permeate water. The test was conducted at about 200 psi. FIG. 8 shows that the flow rate of the softened permeate water decreased with time indicating membrane fouling due to calcium carbonate scale precipitation.

### EXAMPLE 6

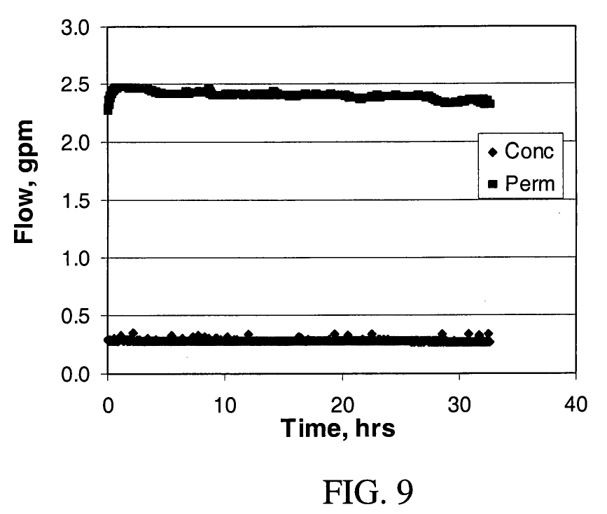

The membrane module of Example 5 was tested in similar conditions, however, effluent water was continuously recycled into the membrane to maintain a constant high velocity across the membrane surface and break the ionic boundary layer or concentration polarization via increased turbulence. In this example, the effluent flow rate remained constant indicating that the membrane surface was being flushed of ions that accumulate and cause scaling. FIG. 9 shows that the flow rate of the softened permeate water remained substantially constant over time.

### EXAMPLE 7

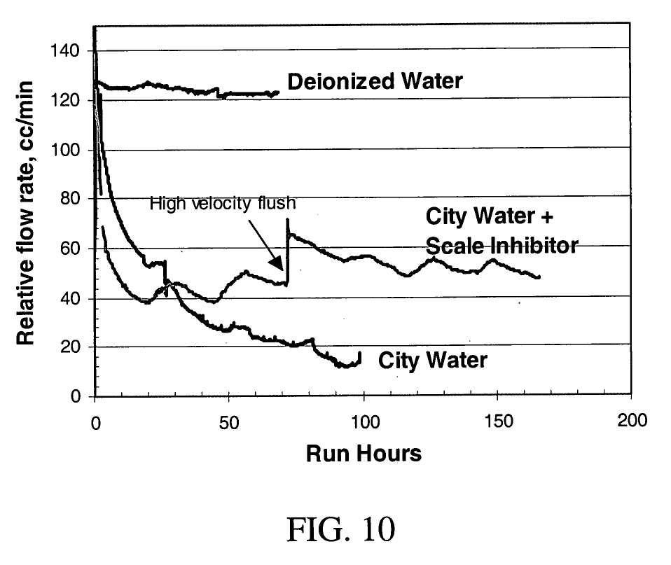

A Premier reverse osmosis membrane module, 12 inches in length was tested in an laboratory unit with water from the Town of Niskayuna in New York State under recycle conditions in order to maintain a constant 90% water recovery. As shown in FIG. 10, there was a decrease in water flow if no scale inhibitors were added. The flow of water was maintained constant when 10 ppm of Betz Hypersperse MDC-150 was added to the recycle loop stream. The results indicate that addition of the inhibitor prevented the formation of calcium carbonate scale that reduces the water flux across the membrane.

### EXAMPLE 8

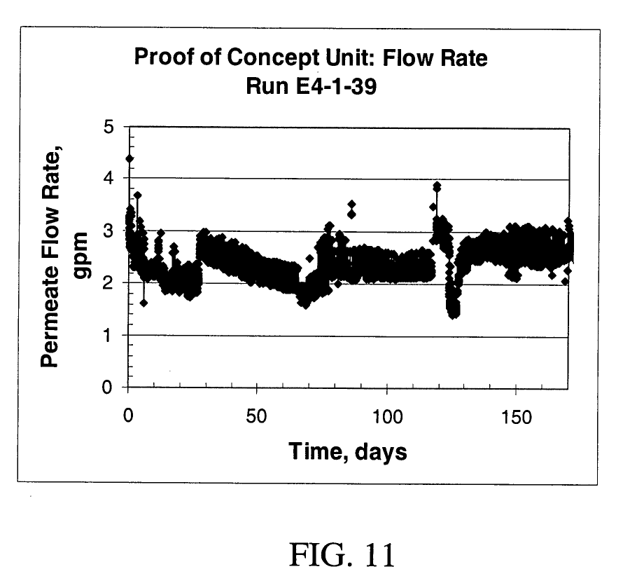

A polyamide AP membrane wound on a spiral wound size module (4 inches in diameter and 40 inches in length), having a total area of about 90 square feet of membrane was tested with water from the Town of Niskayuna in New York State having 10-12 grains per gallon hardness in the feed at a pH of about 7.2. A scale inhibitor was added that varied in the range of about 2.5 to about 10 ppm of Hypersperse MDC-150. This configuration softened water at about 2.5 gal/min and had a water recovery varying from about 75% to about 85% using a recycle flow around the membrane at 150 psi of feed pressure. As shown in FIG. 11, the softened water had 2-3 grains/gal, and there was a constant product water flow rate obtained for 150 days of operation.

It is apparent that there has been provided in this invention a system and method for conditioning water. While the invention has been particularly shown and described in conjunction with preferred embodiments thereof, it will be appreciated that variations and modifications can be effected by a person of ordinary skill in the art without departing from the scope of the invention.

What is claimed is:

1. A water conditioning device, comprising:
a softening membrane that selectively rejects hardness ions in a supply of water, wherein the softening membrane is configured to receive an input flow of water, discharge an output flow of softened permeate water and discharge an output flow of first concentrate water; and
a purification device configured to remove impurities from a portion of the output flow of softened permeate water and discharge an output flow of second concentrate water.

2. The device according to claim 1, wherein the softening membrane comprises a nanofiltration membrane or a loose reverse osmosis membrane.

3. The device according to claim 1, wherein the output flow of softened permeate water is at least 80 percent of the input flow of water.

4. The device according to claim 1, wherein the output flow of softened permeate water is at least 90 percent of the input flow of water.

5. The device according to claim 1, wherein the output flow of first concentrate water is less than 20 percent of the input flow.

6. The device according to claim 1, wherein the output flow of first concentrate water is less than 10 percent of the input flow.

7. The device according to claim 1, wherein the softening membrane removes at least 85 percent of hardness ions from the input flow.

8. The device according to claim 1, wherein the output flow of softened permeate water has a hardness ranging from about 0.1 to about 3 grains per gallon.

9. The device according to claim 1, wherein the output flow of softened permeate water has a hardness ranging from about 1 to about 3 grains per gallon.

10. The device according to claim 1, wherein the softening membrane has a permeability A value that ranges from about 15 to about 50.

11. The device according to claim 1, wherein the input flow of water is less than 15 gallons per minute.

12. The device according to claim 1, wherein the input flow of water has a pressure that is greater than 20 pounds per square inch.

13. The device according to claim 1, wherein the impurities comprise minerals, contaminants and bacteria.

14. A system for conditioning water, comprising:
a conditioning agent dosing unit configured to supply at least one conditioning agent to an input flow of water; and
a softening membrane that selectively rejects hardness ions in the conditioned flow of water, wherein the softening membrane is configured to discharge an output flow of softened permeate water and discharge an output flow of first concentrate water, wherein a portion of the first concentrate water is recycled back through the conditioning agent dosing unit and softening membrane, wherein the at least one conditioning agent prevents membrane fouling.

15. The system according to claim 14, wherein the softening membrane comprises a nanofiltration membrane or a loose reverse osmosis membrane.

16. The system according to claim 14, wherein the output flow of softened permeate water is at least 80 percent of the input flow of water.

17. The system according to claim 14, wherein the softening membrane removes at least 85 percent of hardness ions from the input flow.

18. The system according to claim 14, wherein the output flow of softened permeate water has a hardness ranging from about 1 to about 3 grains per gallon.

19. The system according to claim 14, wherein the softening membrane has a permeability A value that ranges from about 15 to about 50.

20. The system according to claim 14, wherein the softening membrane is substantially resistant to chlorine.

21. The system according to claim 14, wherein the at least one conditioning agent comprises one of a scale inhibitor, an antiscalant, a biofoulant suppressant or combinations thereof.

22. The system according to claim 14, wherein the at least one conditioning agent comprises membrane cleansing.

23. The system according to claim 14, further comprising a purification device configured to remove impurities from a portion of the output flow of softened permeate water and discharge an output flow of second concentrate water.

24. The system according to claim 23, wherein the purification device comprises a loose reverse osmosis membrane.

25. The system according to claim 14, further comprising a water quality monitoring unit configured to monitor water quality of the output flow of softened permeate water and the portion of first concentrate water recycled back through the conditioning agent dosing unit and softening membrane.

26. The system according to claim 25, wherein the water quality monitoring unit comprises a control unit configured to control the supply of the at least one conditioning agent to the input flow of water in accordance with the monitored water quality.

27. The system according to claim 14, further comprising a pump configured to increase pressure of the input flow of water entering the softening membrane.

28. The system according to claim 14, further comprising at least one filter configured to filter the input flow of water entering the softening membrane.

29. A residential water system, comprising:
at least one filter configured to filter an input flow of water;
a conditioning agent dosing unit configured to supply at least one conditioning agent to the filtered input flow of water;
a softening membrane that selectively rejects hardness ions in the conditioned flow of water, wherein the softening membrane is configured to discharge an output flow of softened permeate water and discharge an output flow of first concentrate water, wherein a portion of the first concentrate water is recycled back through the conditioning agent dosing unit and softening membrane, wherein the at least one conditioning agent prevents membrane fouling; and
a water quality monitoring unit configured to monitor water quality of the output flow of softened permeate water and the portion of first concentrate water recycled back through the conditioning agent dosing unit and softening membrane.

30. The system according to claim 29, further comprising a purification device configured to remove impurities from a portion of the output flow of softened permeate water and discharge an output flow of second concentrate water.

31. The system according to claim 29, wherein the purification device comprises a loose reverse osmosis membrane.

32. The system according to claim 29, wherein the softening membrane removes at least 85 percent of hardness ions from the input flow.

33. The system according to claim 29, wherein the output flow of softened permeate water is at least 80 percent of the input flow of water.

34. The system according to claim 29, wherein the output flow of softened permeate water has a hardness ranging from about 1 to about 3 grains per gallon.

35. The system according to claim 29, wherein the softening membrane has a permeability A value that ranges from about 15 to about 50.

36. The system according to claim 29, wherein the softening membrane is substantially resistant to chlorine.

37. The system according to claim 29, wherein the at least one conditioning agent comprises one of a scale inhibitor, an antiscalant, a biofoulant suppressant or combinations thereof.

38. The system according to claim 29, wherein the at least one conditioning agent comprises membrane cleansing.

39. The system according to claim 29, wherein the water quality monitoring unit comprises a control unit configured to control the supply of the at least one conditioning agent to the input flow of water in accordance with the monitored water quality.

40. The system according to claim 29, further comprising a pump configured to increase pressure of the input flow of water entering the softening membrane.

41. The system according to claim 29, wherein the softening membrane comprises a nanofiltration membrane or a loose reverse osmosis membrane

42. A method for conditioning water, comprising:
receiving an input flow of water;
supplying at least one conditioning agent to the input flow of water to prevent scale formation;
using a softening membrane to selectively reject hardness ions in the water,
discharging an output flow of softened permeate water;
discharging an output flow of first concentrate water; and
recycling a portion of the first concentrate water back for supply of at least one conditioning agent and use of the softening membrane.

43. The method according to claim 42, wherein the softening membrane comprises a nanofiltration membrane or a loose reverse osmosis membrane

44. The method according to claim 42, wherein the output flow of softened permeate water is at least 80 percent of the input flow of water.

45. The method according to claim 44, wherein the softening membrane removes at least 85 percent of hardness ions from the input flow.

46. The method according to claim 42, wherein the output flow of softened permeate water has a hardness ranging from about 1 to about 3 grains per gallon.

47. The method according to claim 42, wherein the softening membrane has a permeability A value that ranges from about 15 to about 50.

48. The method according to claim 42, wherein the softening membrane is substantially resistant to chlorine.

49. The method according to claim 42, wherein the at least one conditioning agent comprises one of a scale inhibitor, an antiscalant, a biofoulant suppressant or combinations thereof.

50. The method according to claim 42, wherein the at least one conditioning agent comprises membrane cleansing.

51. The method according to claim 42, further comprising removing impurities from a portion of the output flow of softened permeate water.

52. The method according to claim 42, further comprising monitoring water quality of the output flow of softened permeate water and the portion of recycled first concentrate water.

53. The method according to claim 52, further comprising controlling the supply of the at least one conditioning agent to the input flow of water in accordance with the monitored water quality.

54. The method according to claim 42, further comprising filtering the input flow of water entering the softening membrane.

55. The method according to claim 42, further comprising flushing the softening membrane with fresh feed water or softened water at the end of an operational cycle.
